(19) United States
(12) Patent Application Publication
(10) Pub. No.: US 2011/0018878 A1
(43) Pub. Date: Jan. 27, 2011

(54) IMAGE DELIVERY SYSTEM, IMAGE DELIVERY APPARATUS, IMAGE DELIVERY METHOD AND PROGRAM, AND RECORDING MEDIUM

(75) Inventor: Kentaro MIYAMOTO, Tokyo (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: FUJIFILM CORPORATION, Tokyo (JP)

(21) Appl. No.: 12/841,028

(22) Filed: Jul. 21, 2010

(30) Foreign Application Priority Data
Jul. 22, 2009 (JP) JP2009-171398

(51) Int. Cl. G06T 3/40

(52) U.S. Cl. 345/428

(57) ABSTRACT

In the image delivery system of an embodiment of the present invention, a text image is generated which is image data converted from document data in formats such as Word or PDF, a display area is determined on the text image, and a text image within the determined display area (hereinafter referred to as a delivery image) is input to an image conversion processing unit. The image conversion processing unit converts a resolution and a pixel count of the delivery image to a resolution and a pixel count appropriate for the display device based on a pixel count, a resolution, etc. of a display unit to send to a client portable terminal. The client portable terminal displays the sent delivery image on the display device. This enables to display the delivery image at the same size regardless of a display device.

### BACKGROUND OF THE INVENTION

1. Field of the Invention

The present invention relates to an image delivery system, an image delivery apparatus, an image delivery method and a program, and recording medium therefor, and particularly relates to an image delivery system, an image delivery apparatus, an image delivery method and a program, and recording medium therefor which send from an image delivery apparatus to a portable terminal image data in accordance with a size and a resolution of a display apparatus disposed on the portable terminal.

2. Description of the Related Art

As cellular phones become popular, cellular phones are increasingly used for business purposes. For example, there is a demand of securely viewing and editing files, mails, etc. stored in an in-house server using a cellular phone from an outside location.

It is common to allow viewing and editing documents such as Word or PDF documents directly on a browser by setting document links to documents such as Word or PDF documents within an HTML document. However, on a terminal which cannot open a Word or PDF document such as a cellular phone, it is impossible to view a document from a document link within an HTML document.

Thus, when a terminal which cannot open a Word or PDF document such as a cellular phone accesses a text link, such problem is solved by converting a designated text to an image suited for a destination cellular phone and delivering it, but when a document or others are displayed on a terminal having a small display screen such as a cellular phone, an image larger than the size of the display screen is displayed, causing poor visibility.

In Japanese Patent Application Laid-Open No. 2007-256401, an invention is disclosed which determines whether a displayed image is a text image or not when displaying an image larger than a display screen and, if it is a text image, scroll-controls the image displayed on a display device in a scroll form which is different from that of the case where the displayed image is not a text image.

In Japanese Patent Application Laid-Open No. 2001-197298, an invention is disclosed which, in video telephony, sends to the other communication end a low-resolution image imaged by cull controlling of pixels if a resolution of a display apparatus of the other communication end is low.

### SUMMARY OF THE INVENTION

However, with the invention disclosed in the Japanese Patent Application Laid-Open No. 2007-256401, there is a problem that the size of an image displayed may change depending on a display device because a liquid crystal display resolution is not considered. In other words, even if the same image is displayed, the image is displayed larger on a display device having a low liquid crystal display resolution and smaller on a display device having a high liquid crystal display resolution.

Also, even though the invention disclosed in the Japanese Patent Application Laid-Open No. 2001-197298 changes a resolution of an image to be sent according to a resolution of a display apparatus of the other communication end, it obtains a low-resolution image by cull imaging and cannot be adapted to document data.

The present invention has been achieved in view of these conditions, and it is an object of the present invention to provide an image delivery system, an image delivery apparatus, an image delivery method and a program which can generate image data from document data and display the image data on a display device at the same size regardless of a pixel count or resolution of the display device.

An image delivery system of a first aspect of the present invention is an image delivery system comprising a portable terminal used by a user and an image delivery apparatus connected to the portable terminal, wherein the portable terminal comprises a display device, a terminal-side reception device which receives a delivery image sent from the image delivery apparatus, and a display control device which displays on the display device the delivery image received by the terminal-side reception device, the image delivery apparatus comprises a document data acquisition device which acquires document data which the display control device cannot display on the display device, a display device information acquisition device which acquires a pixel count or resolution of the display device, a display area determining device which determines a display area having a predetermined size on the document data, an image generating device which generates a delivery image made by imaging document data within the determined display area, a conversion device which converts a pixel count or resolution of the generated delivery image based on a pixel count or resolution of the display device so that the delivery image is displayed at the same size regardless of a pixel count or resolution of the display device, and an apparatus-side send device which sends to the portable terminal the delivery image within the display area whose pixel count or resolution is converted by the conversion device.

In accordance with the image delivery system of the first aspect, document data which cannot be displayed on a display device is acquired, a display area having a predetermined size is determined, and a delivery image which is made by imaging document data within the display area is generated. A pixel count or resolution of a display device is acquired, a pixel count or resolution of a delivery image is converted so that the delivery image is displayed at the same size regardless of a pixel count or resolution of the display device, and the delivery image is sent to a portable terminal. The portable terminal receives the delivery image to display on the display device. This allows even a portable terminal which cannot open document data such as a Word or PDF document to view desired document data. Also, regardless of a pixel count or resolution of a display device, a delivery image can be displayed on the display device at the same size.

An image delivery system of a second aspect of the present invention is the image delivery system according to the first aspect, wherein the display device information acquisition device acquires a size of the display device, and the display area determining device determines a display area having the predetermined size which is substantially the same as the size of the display device.

In accordance with the image delivery system of the second aspect, a display area having a size which is substantially the same as a size of a display device is determined. This enables to display the whole display area on the display device.

An image delivery system of a third aspect of the present invention is the image delivery system according to the first or second aspect, wherein the image delivery apparatus comprises a file analysis device which analyzes a layout or letter size of the document data, and the display area determining device sets a display area having a predetermined size on the document data based on the result of the analysis.

In accordance with the image delivery system of the third aspect, a layout or letter size of the document data is analyzed, and a display area having a predetermined size is determined on document data based on the result of the analysis. By determining a display area so that an image which enables to grasp the outline of a document is displayed like this, it is possible to save the effort of designating a display area.

An image delivery system of the fourth aspect of the present invention is the image delivery system according to any of the first to third aspects, wherein the portable terminal comprises an operating unit which inputs information indicating a desired display area in accordance with an instruction by the user and a terminal-side send device which sends the input information indicating a desired display area to the image delivery apparatus, the image delivery apparatus comprises an apparatus-side reception device which receives the information indicating a desired display area sent from the terminal-side send device, the display area determining device making, based on the received information indicating a desired display area, the desired display area an display area determined on the document data.

In accordance with the image delivery system of a fourth aspect, a portable terminal inputs information indicating a desired display area in accordance with an instruction by the user and sends it to the image delivery apparatus. The image delivery apparatus receives the information indicating a desired display area and generates a delivery image made by imaging document data within the desired display area. In this way, a delivery image as instructively input by the portable terminal can be displayed on a display unit.

An image delivery system of a fifth aspect of the present invention is the image delivery system according to any of the first to fourth aspects, wherein when a new delivery image is received from the terminal-side reception device after displaying a delivery image on the display device, the display control device erases the delivery image and displays the new delivery image on the display device.

In accordance with the image delivery system of the fifth aspect, when a new delivery image is received after displaying a delivery image on the display device, the delivery image currently displayed is erased and the new delivery image is displayed on the display device. In this way, previous images do not remain in a portable terminal, enabling safe viewing of a document.

An image delivery system of a sixth aspect of the present invention is the image delivery system according to any of the first to fifth aspects, wherein the image delivery apparatus comprises a storage device which stores an application with which the delivery image can be viewed, the send device sends an application stored in the storage device to the portable terminal, the display control device runs the sent application to display the sent delivery image on the display device.

In accordance with the image delivery system of the sixth aspect, the image delivery apparatus sends an application with which a delivery image can be viewed to a portable terminal, and the portable terminal runs the application to display the delivery image. In this way, a portable terminal without the application cannot view a delivery image, enabling safe viewing of a document.

An image delivery apparatus of a seventh aspect of the present invention constitutes an image delivery system according to any of the first to sixth aspects.

An image delivery method of an eighth aspect of the present invention includes the steps of acquiring document data, acquiring a pixel count or resolution of a display device disposed on a portable terminal, converting the document data to image data, determining a display area having a predetermined size on the image data, converting a pixel count or resolution of image data within the determined display area based on a pixel count or resolution of the display device so that the delivery image is displayed at the same size regardless of a pixel count or resolution of the display device, and sending to the portable terminal the image data within the display area with which the pixel count or resolution has been converted.

A program of a ninth aspect of the present invention makes an arithmetic unit perform the image delivery method according to the eighth aspect.

A tenth aspect of the present invention provides a recording medium in which computer readable code of the program of the ninth aspect is stored.

In accordance with the present invention, it is possible to generate image data from document data and display the image data on a display device at the same size regardless of a pixel count or resolution of the display device.

### BRIEF DESCRIPTION OF THE DRAWINGS

FIG. 1 is a schematic diagram of an image delivery system 1 to which the present invention is applied;

FIG. 2 is an example of a model data management table;

FIGS. 3A, 3B and 3C are diagrams describing a display area, wherein FIG. 3A shows a case in which the whole text image is a display area, FIG. 3B showing a case in which an area having a predetermined size (about ¼) at the upper left of a text image is a display area, FIG. 3C showing a case in which an area having a predetermined size (about ¼) at the substantial center of a text image is a display area;

FIG. 4 is an example of a document link conversion method management table;

FIG. 5 is an example of an initial screen;

FIG. 6 is a flow chart showing a processing flow of the image delivery system 1;

FIG. 7A is a diagram showing a relationship between a text image and a delivery image, and FIGS. 7B and 7C are diagrams describing a process of converting a delivery image according to a display unit 21;

FIG. 8 is a schematic diagram of an image delivery system 2 to which the present invention is applied;

FIG. 9 is an example of a display area;

FIGS. 10A and 10B are examples of a display area;

FIG. 11 is a diagram describing a method of determining a position of a display area based on a layout of a document image;

FIG. 12 is a diagram describing a method of determining a display area;

FIG. 13 is a diagram describing a method of determining a position of a display area based on font sizes of a document image; and

FIG. 14 is a flow chart showing a processing flow of the image delivery system 2.

### DETAILED DESCRIPTION OF THE PREFERRED EMBODIMENTS

### First Embodiment

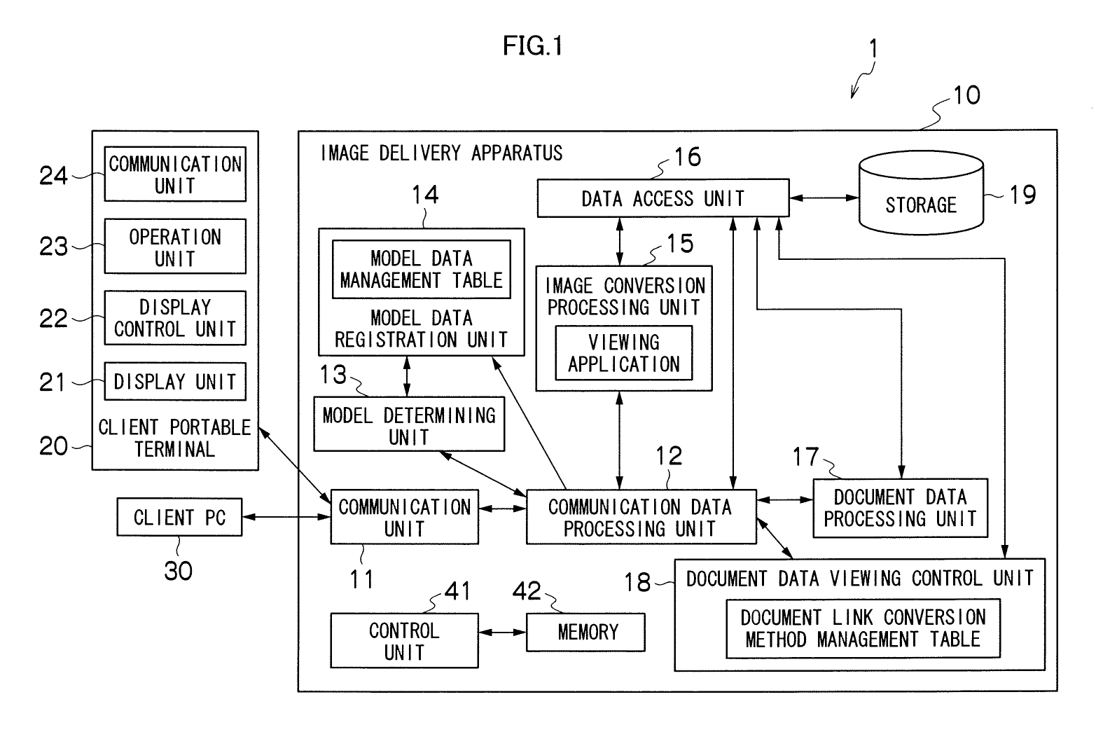

FIG. 1 is a schematic diagram of the whole structure of an image delivery system 1 of the first embodiment. The image delivery system 1 mainly includes an image delivery apparatus 10, a client portable terminal 20 and a client PC 30. Even though one client portable terminal 20 is depicted as a portable terminal for a client in FIG. 1, a plurality of client portable terminals 20 may be included. Also, the client PC 30 is not mandatory, and the image delivery apparatus 10 and the client portable terminal 20 are minimum requirements.

The image delivery apparatus 10 includes a communication unit 11, a communication data processing unit 12, a model determining unit 13, a model data registration unit 14, an image conversion processing unit 15, a data access unit 16, a document data processing unit 17, a document data viewing control unit 18 and a storage 19.

The communication unit 11 receives portable terminal information, image data send command, etc. sent from the client portable terminal 20.

The communication data processing unit 12 determines what kind of data the data received by the communication unit 11 is and, according to the result of the determination, outputs the data to the model determining unit 13 and others.

The model determining unit 13 determines a model of the client portable terminal 20 based on portable terminal information sent from the client portable terminal 20. Also, the model determining unit 13 refers to a model data management table stored in the model data registration unit 14 and acquires a liquid crystal display size, a liquid crystal display resolution and a pixel count of the client portable terminal 20.

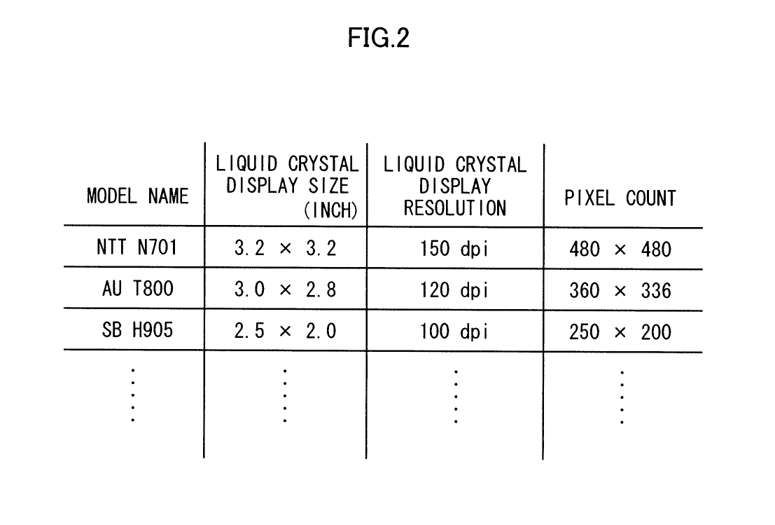

The model data registration unit 14 stores a model data management table in which a model, a liquid crystal display size, a liquid crystal display resolution, and a pixel count are associated each other as shown in FIG. 2. Also, when model data sent from the client PC 30 is input from the communication data processing unit 12, the model data registration unit 14 registers the model data in the model data management table.

The image conversion processing unit 15 acquires document data in data formats such as Word or PDF from the storage 19 via the data access unit 16, and converts the acquired document data to image data to generate image data of the document data (hereinafter referred to as a document image). Since viewing applications for images differ according to a portable terminal and displayable image data differs according to a viewing application, the image conversion processing unit 15 generates different kinds of document images for one document data per viewing application. Also, if text data includes a plurality of pages, the image conversion processing unit 15 generates a document image per page. The image conversion processing unit 15 stores the generated document images to the storage 19 via the data access unit 16.

Also, the image conversion processing unit 15 acquires a document image (delivery image) within a display area output from the document data processing unit 17 via the data access unit 16, and converts a resolution, a pixel count, etc. of the document image within the display area so that the document image can be properly displayed on the client portable terminal 20. This is because since a liquid crystal display size, a liquid crystal display resolution and a pixel count of a display unit differ according to each portable terminal, the same document image output may not necessarily be displayed in the same way. The details of a process in which the image conversion processing unit 15 adjusts a document image within a display area will be described later in detail.

Also, the image conversion processing unit 15 stores viewing applications used when a document image is viewed on the client portable terminal 20. Since viewing applications differ according to each portable terminal, the image conversion processing unit 15 stores a plurality of viewing applications.

The data access unit 16 acquires necessary data from the storage 19 according to instructions from the communication data processing unit 12, the image conversion processing unit 15, the document data processing unit 17 and the document data viewing control unit 18 to output to each of the processing units.

The document data processing unit 17 acquires a document image stored in the storage 19 and determines a display area on the acquired document image. The method of determining a display area will now be described.

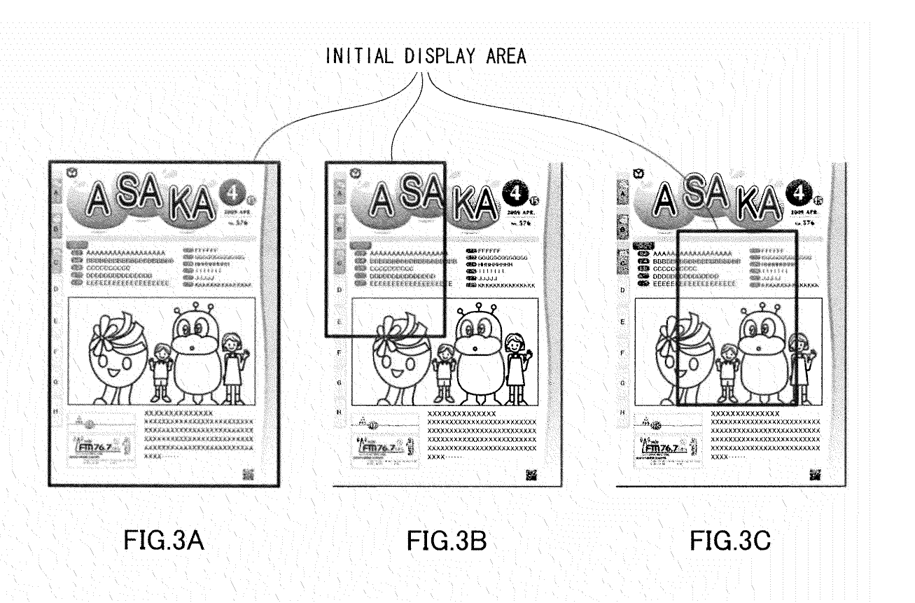

As conditions of a display area, the document data processing unit 17 stores, for example, a whole text image (FIG. 3A), an area having a predetermined size (about ¼) at the upper left of a text image (FIG. 3B), and an area having a predetermined size (about ¼) at the substantial center of a text image (FIG. 3C). The document data processing unit 17 determines a display area based on conditions set by initial settings, user settings, etc. If the client PC 30 has set that a display area is determined by using a condition of a predetermined size at the upper left of a text image (FIG. 3B), the document data processing unit 17 makes an area having a predetermined size at the upper left of a text image a display image.

The predetermined size is not restricted to about ¼ of a text image. For example, based on a liquid crystal display size, a liquid crystal display resolution and a pixel count of the client portable terminal 20, the predetermined size may be substantially equal to the liquid crystal display size of the client portable terminal 20 acquired by the model determining unit 13. In this case, the document data processing unit 17 specifies a size of a display area in a unit of length such as an inch or a centimeter instead of a unit of pixel. This is for ensuring that the same area is displayed in the same way regardless of a model of the client portable terminal 20.

Then, the document data processing unit 17 outputs a document image within a display area (hereinafter referred to as a delivery image) to the image conversion processing unit 15 via the data access unit 16.

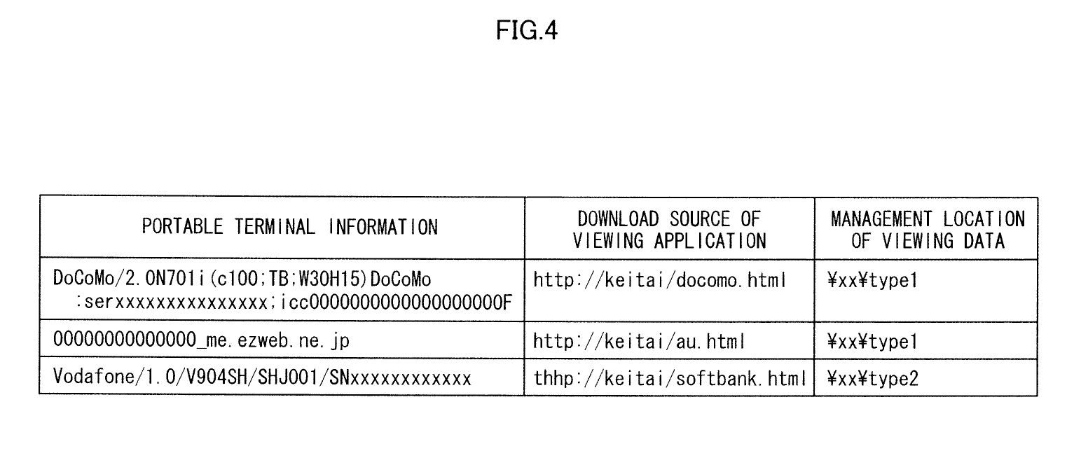

The document data viewing control unit 18 stores a document link conversion method management table in which portable terminal information, an address of a download source of a viewing application, and a management location of viewing data are associated each other, as shown in FIG. 4. The document link conversion method management table indicates, for example, that if portable terminal information is DoCoMo/2.0N701i (c100;TB;W30H1)/serxxxxxxxxxxxxxxx;icc0000000000F, a viewing application for this portable terminal is stored at http://keitai/docomo.html (within the image conversion processing unit 15) and a document image generated for this portable terminal at the image conversion processing unit 15 is stored at ¥xx¥type1 (within the storage 19).

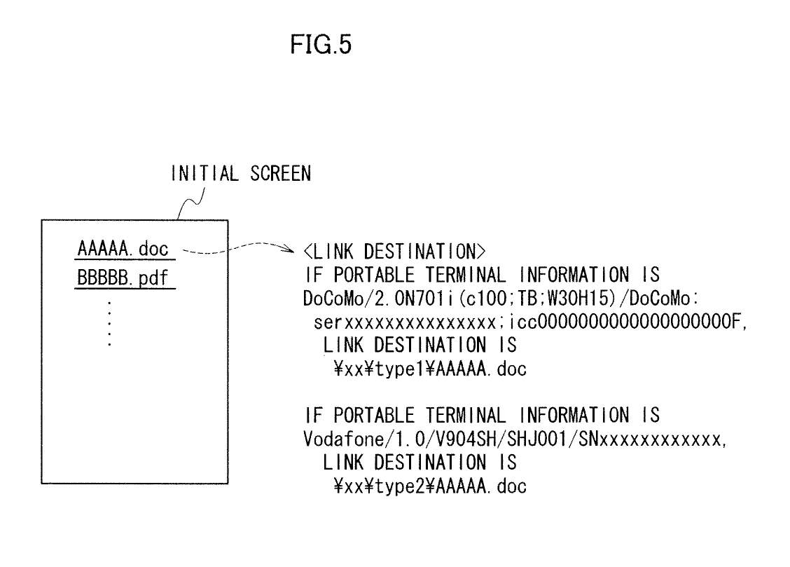

Also, the document data viewing control unit 18 generates an initial screen in an HTML format in which links to document images are included. The initial screen is the one in which a list of file names of document data stored in the storage 19 is displayed, and strings representing each of the file names have links to document data having the file names, as shown in FIG. 5. At this point, the document data viewing control unit 18 refers to a document link conversion method management table, and generates the initial screen in which links to each of document data in the initial screen are converted to links to different files which can be viewed with each viewing application. For example, when letters “AAAAA.doc” are displayed on the initial screen and a link to document data called AAAAA is generated for that letters, if portable terminal information is DoCoMo/2.0N701i (c100;TB;W30H1)/serxxxxxxxxxxxxxxx;icc0000000000F, a link to a text image of AAAAA stored at ¥xx¥type1 is generated, and if portable terminal information is Vodafone/1.0/V904SH/SHJ001/SNxxxxxxxxxxxx, a link to a text image of AAAAA stored at ¥xx¥type2 is generated.

The storage 19 stores document data in formats such as Word or PDF input from the client PC 30 via the communication unit 11.

Also, the storage 19 stores different kinds of document images generated for each viewing application by the image conversion processing unit 15 at different locations for each of the kinds. For example, a text image for a viewing application stored at http://keitai/docomo.html is stored at ¥xx¥type1, and a text image for a viewing application stored at http://keitai/softbank.html is stored at ¥xx¥type2.

Also, the image delivery apparatus 10 includes a control unit 41, and the control unit 41 integrally controls the entire operation of the image delivery apparatus 10 as well as acts as a computing device for performing various kinds of arithmetic processing. Also, the image delivery apparatus 10 includes a memory 42 such as EEPROM, and the memory 42 stores programs necessary for various kinds of control. The control unit 41 and the memory 42 are connected to the components of the image delivery apparatus 10.

The client portable terminal 20 is a cellular phone, for example, and connected to the image delivery apparatus 10 via a network. The client portable terminal 20 mainly includes a display unit 21, a display control unit 22 and an operation unit 23. Other components and functions of the client portable terminal 20 are already well-known and thus will not be described.

The display unit 21 is a liquid crystal display which is compatible with color display. The display unit 21 is not restricted to a liquid crystal display and an organic EL display and others may be used.

The display control unit 22 displays on the display unit 21 an initial screen sent from the image delivery apparatus 10. Also, the display control unit 22 runs an application sent from the image delivery apparatus 10 and displays on the display unit 21 image data sent from the image delivery apparatus 10.

The operation unit 23 is for a user to input various instructions and includes a numeric keypad, a cross key, a phone call button, etc.

The communication unit 24 receives an initial screen, an application, image data, etc. sent from the image delivery apparatus 10.

Furthermore, the client portable terminal 20 includes a control unit not shown, and the control unit integrally controls the entire operation of the client portable terminal 20 as well as acts as a computing device for performing various kinds of arithmetic processing. Also, the client portable terminal 20 includes a storage device not shown, and the storage device stores portable terminal information of the client portable terminal 20 and programs necessary for various kinds of control.

The client PC 30 is, for example, a personal computer (PC) and connected to the image delivery apparatus 10 via a network. The client PC 30 updates a model data management table stored in the model data registration unit 14 and various document data stored in the storage 19, and do other things. The configuration and functions of the client PC 30 are already well-known and thus will not be described.

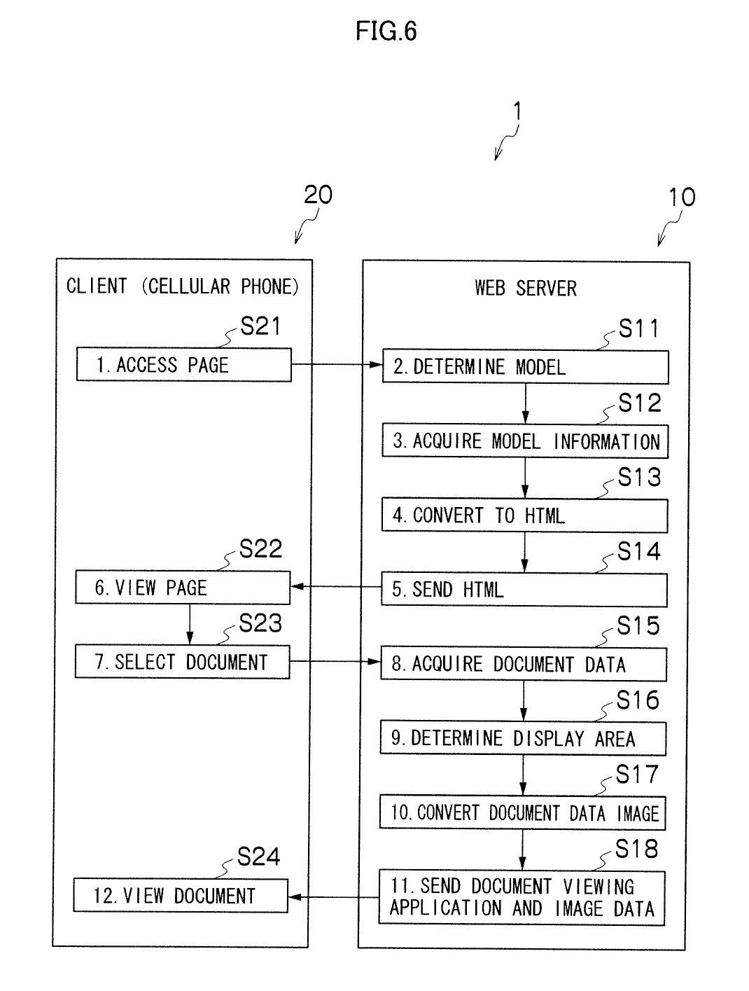

The operation of the image delivery system 1 configured as above will now be described. FIG. 6 is a flow chart showing a processing flow of allowing the client portable terminal 20 to view document data.

When a user accesses a particular page by operating the operation unit 23, the system starts, and the control unit of the client portable terminal 20 sends portable terminal information from the communication unit 24 to the image delivery apparatus 10 (step S21).

The communication data processing unit 12 of the image delivery apparatus 10 acquires the portable terminal information via the communication unit 11 to output to the model determining unit 13, and the model determining unit 13 analyzes the portable terminal information to determine the model of the client portable terminal 20 (step S11). This is because a liquid crystal display size, a liquid crystal display resolution, a pixel count, etc. as well as a viewing application for a document image differ according to a model of a cellular phone. For determining a model, user agents, carrier IDs, etc. are used. For example, if DoCoMo/2.0N701i (c100;TB;W30H1)/serxxxxxxxxxxxxxxx;icc0000000000F is acquired as portable terminal information, the model determining unit 13 determines that the model of the client portable terminal 20 is NTT N701.

Also, the model determining unit 13 refers to a model data management table stored in the model data registration unit 14 and acquires the model information of the client portable terminal 20, such as the information of the display unit 21 (step S12). For example, if the model of the client portable terminal 20 is determined as NTT N701 in step S11, the model determining unit 13 refers to the model data management table shown in FIG. 2, and acquires a liquid crystal display size (3.2×3.2 inches), a liquid crystal display resolution (150 dpi), and a pixel count (480×480 pixels) as the information of the display unit of NTT N701.

The communication data processing unit 12 outputs the portable terminal information acquired via the communication unit 11 to the document data viewing control unit 18. The document data viewing control unit 18 generates, based on the portable terminal information and the document link conversion method management table shown in FIG. 3, an initial screen to be sent to the client portable terminal 20 (step S13). For example, if the model of the client portable terminal 20 is determined as NTT N701 in step S11, the document data viewing control unit 18 generates an initial screen including a link to a text image stored at ¥xx¥type1.

The communication data processing unit 12 acquires the initial screen in an HTML format generated in step S13 from the document data viewing control unit 18 to output to the communication unit 11, and the communication unit 11 sends the initial screen in an HTML format to the client portable terminal 20 (step S14).

The communication unit 24 of the client portable terminal 20 receives the initial screen in an HTML format to output to the display control unit 22, and the display control unit 22 displays the initial screen in an HTML format on the display unit 21 (step S22). In the initial screen in an HTML format, document data stored in the storage 19 is selectably displayed.

When a user selects a desired document among document data displayed on the initial screen in an HTML format by operating the operation unit 23, the control unit of the client portable terminal 20 sends to the image delivery apparatus 10 via the communication unit 24 the information indicating which document was selected (step S23). For example, if the initial screen shown in FIG. 5 is displayed on the display unit 21 and AAAAA.doc is selected by the operation unit 23, the control unit of the client portable terminal 20 sends to the image delivery apparatus 10 via the communication unit 24 the information indicating that the document “AAAAA.doc” was selected.

The communication data processing unit 12 acquires via the communication unit 11 the information about the selected document to output to the document data processing unit 17, and the document data processing unit 17 acquires from the storage unit 19 via the data access unit 16 a text image which is a document image of the selected document and can be viewed on the client portable terminal 20 (step S15). For example, if the model of the client portable terminal 20 is determined as NTT N701 in step S11 and the information indicating that the document “AAAAA.doc” was selected is sent in step S23, the document data processing unit 17 acquires a text image of AAAAA.doc from ¥xx¥type1.

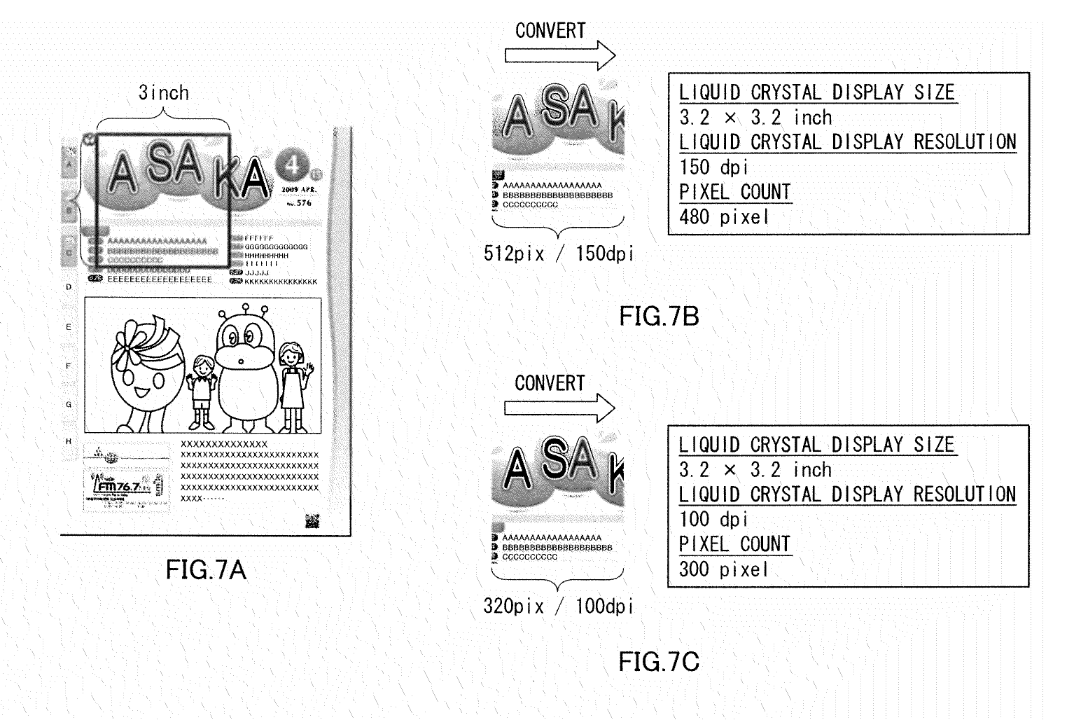

The document data processing unit 17 determines (step S16) a display area on the text image acquired in step S15, and inputs to the image conversion processing unit 15 a text image within the display area determined in step S16 (hereinafter referred to as a delivery image). The image conversion processing unit 15 converts a resolution and a pixel count of the delivery image based on the information of the display unit 21 acquired in step S12 (step S17). The process of step S17 will now be described using a case, as an example, in which the display area determined in step S16 has a size of 3 inches long×3 inches wide, a pixel count of 512 pixels×512 pixels, and a resolution of 150 dpi, as shown in FIG. 7A.

As shown in FIG. 7B, if a liquid crystal display size, a liquid crystal display resolution and a liquid crystal display pixel count of the client portable terminal 20 are 3.2 inches×3.2 inches, 150 dpi and 480 pixels×480 pixels, respectively, the image conversion processing unit 15 performs no conversion processing because the resolution of the display area and the liquid crystal display resolution are the same. On the other hand, as shown in FIG. 7C, if a liquid crystal display size, a liquid crystal display resolution and a liquid crystal display pixel count of the client portable terminal 20 are 3.2 inches×3.2 inches, 100 dpi and 300 pixels×300 pixels, respectively, and the delivery image is displayed on the display unit 21 without modification, only a part of the delivery image is displayed on the display unit 21 and the whole delivery image cannot be displayed on the display unit 21 because the resolution of the delivery image is higher than the liquid crystal display resolution. Thus, the image conversion processing unit 15 evenly culls pixels of the display area and make the resolution of the display area and the liquid crystal display resolution the same. This enables a delivery image to be displayed similarly both when the delivery image is displayed on the display unit shown in FIG. 7B and when the delivery image is displayed on the display unit shown in FIG. 7C. However, the delivery image will be coarser when the image is displayed on the display unit as shown FIG. 7C.

The image conversion processing unit 15 outputs to the communication data processing unit 12 the document image of the display area after being converted in step S17, and the communication data processing unit 12 acquires it. Also, the communication data processing unit 12 refers to a document link conversion method management table (see FIG. 4) stored in the document data viewing control unit 18, and acquires from the image conversion processing unit 15 a viewing application for the portable terminal information acquired in step S11. For example, if the portable terminal information is DoCoMo/2.0N701i (c100;TB;W30H1)/serxxxxxxxxxxxxxxx;icc0000000000F, a viewing application is acquired from http://keitai/docomo.html in the image conversion processing unit 15. Then, the communication data processing unit 12 outputs to the client portable terminal 20 via the communication unit 11 the acquired document image of the display area and viewing application (step S18).

The communication unit 24 of the client portable terminal 20 receives the document image of the display area and the viewing application to output to the display control unit 22. The display control unit 22 runs the viewing application, and the viewing application displays the document image of the display area on the display unit 21 (step S24).

This allows the document selected by a user in step S22 to be displayed on the display unit 21. In this situation, if a user instructs modification of a display area such as moving upward or downward, enlarging or reducing, etc. by operating the operation unit 23, the control unit of the client portable terminal 20 sends to the image delivery apparatus 10 via the communication unit 24 the instruction details input with the operating unit 23.

The communication data processing unit 12 of the image delivery apparatus 10 receives the instruction details via the communication unit 24 to output to the document data processing unit 17. The document data processing unit 17 redetermines a display area according to the input instruction details and outputs it to the image conversion processing unit 15.

The image conversion processing unit 15 converts a resolution and a pixel count of a delivery image based on the information of the display unit 21 acquired in step S12, the image conversion processing unit 15 outputting to the communication data processing unit 12 the document image of the display area that has been redetermined, the communication data processing unit 12 receiving it to send to the client portable terminal 20 via the communication unit 11.

The display control unit 22 of the client portable terminal 20 receives the document image of the display area via the communication unit 24 and displays it on the display unit 21. In this case, since the display control unit 22 is running a viewing application, it is not necessary to receive a viewing application again.

This allows the display area after being modified with the operation unit 23 to be displayed on the display unit 21. At this point, the control unit of the client portable terminal 20 deletes a document image of a display area previously displayed on the display unit 21. When a user finishes viewing a document by operating the operation unit 23, the control unit of the client portable terminal 20 deletes the viewing application run by the display control unit 22 and the currently displayed document image of the display area. Therefore, image data is not stored in the client portable terminal 20 and security is ensured.

According to the present embodiment, even on a portable terminal which cannot open document data such as Word, PDF, etc. it is possible to view desired document data. Also, since no data remains in a portable terminal, there is no possibility that other people view document data in case, for example, a portable terminal or others are lost, thereby ensuring security.

Even though in the present embodiment the model data registration unit 14 has information of a liquid crystal display size, a liquid crystal display resolution and a pixel count as model data, it does not have to have both a liquid crystal display resolution and a pixel count, and having a liquid crystal display size and one of a liquid crystal display resolution and a pixel count is enough. This is because a pixel count can be figured out from a liquid crystal display size and a liquid crystal display resolution, and a liquid crystal display resolution can be figured out from a liquid crystal display size and a pixel count. Thus, as a “liquid crystal display resolution” in the description of the present embodiment, a liquid crystal display resolution stored as model data may be used, or if a liquid crystal display resolution is not included in model data, a liquid crystal display resolution which is calculated from a liquid crystal display size and a pixel count may be used. Likewise, as a “pixel count”, a pixel count stored as model data may be used, or if a pixel count is not included in model data, a pixel count which is calculated from a liquid crystal display size and a liquid crystal resolution may be used.

Also, even though in the present embodiment the control unit of the client portable terminal 20 deletes a viewing application run by the display control unit 22 and the currently displayed document image of the display area when a user finishes viewing a document by operating the operation unit 23, it may delete only the document image of the display area and store the viewing application in a storage unit not shown. In this case, when a text is viewed again, a process of sending a viewing application from the image delivery apparatus 10 can be avoided. However, if security is concerned, it is desirable to delete a viewing application as well, as with the present embodiment.

In the present embodiment, when an image of a display area after modification of the display area is instructed with the operation unit 23 is sent from the image delivery apparatus 10 and displayed on the display unit 21, a document image of a display area previously displayed on the display unit 21 is deleted. However, if the instruction with the operation unit 23 is an enlarging operation, an image may not be received from the image delivery apparatus 10 and the display control unit 22 may perform the enlarging operation.

Also, in the present embodiment, a display area is determined in step S16 on a text image acquired from the storage 19 in step S15, and a resolution and a pixel count of a text image within the display area (delivery image) determined in step S16 are converted in step S17. However, a delivery image in step S17 is not restricted to this form. For example, it may be possible to determine a display area on a text data and make an image made by imaging only that display area a delivery image.

### Second Embodiment

In the first embodiment, the document data processing unit 17 determines a display area based on the set conditions, but a method of determining a display area is not restricted to this.

The second embodiment is an embodiment in which text data is analyzed to determine an optimum area for that text data as a display area. An image delivery system 2 of the second embodiment will now be described. Like numerals depict like parts with respect to the first embodiment to avoid duplication of explanation.

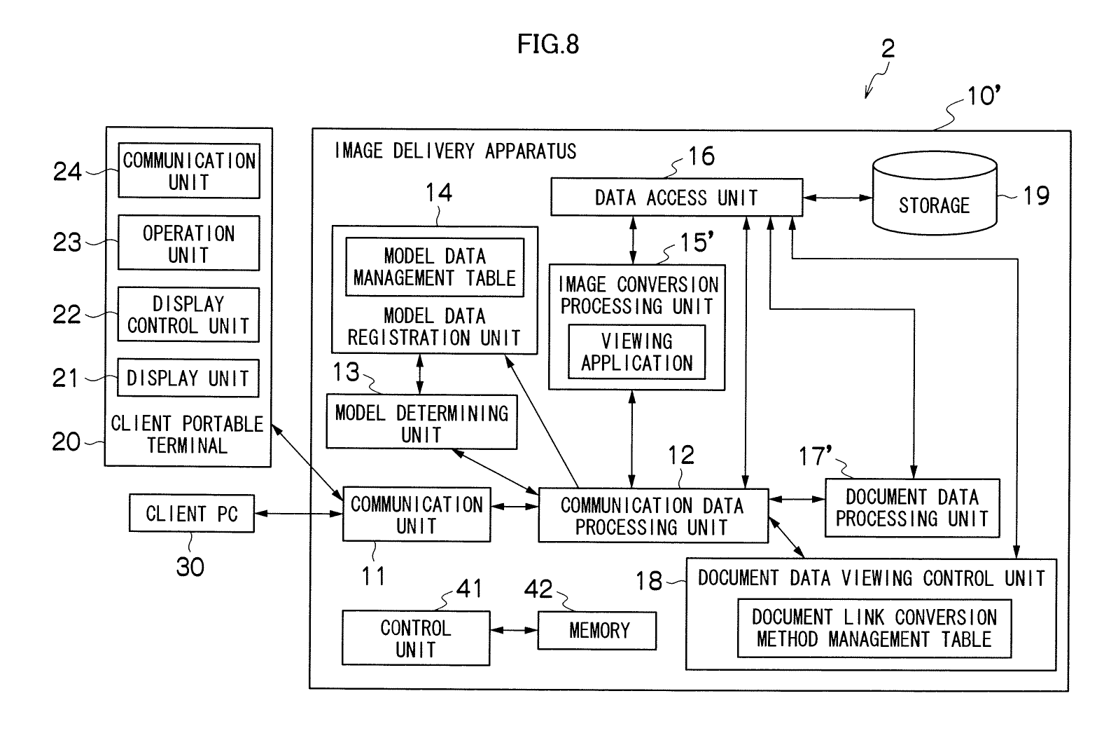

FIG. 8 is a schematic diagram of the whole structure of the image delivery system 2 of the second embodiment. The image delivery system 2 mainly includes an image delivery apparatus 10′, a client portable terminal 20 and a client PC 30.

The image delivery apparatus 10′ includes a communication unit 11, a communication data processing unit 12, a model determining unit 13, a model data registration unit 14, an image conversion processing unit 15′, a data access unit 16, a document data processing unit 17′, a document data viewing control unit 18 and a storage 19.

The image conversion processing unit 15′ refers to a viewing application and modifies the size of a display area so that letters are displayed at desired sizes. The method in which the image conversion processing unit 15′ modifies the size of a display area will now be described.

The image conversion processing unit 15′ analyzes font sizes of a display area by using a font size analyzing function of a printer driver, OCR technology, etc., refers to a viewing application, and modifies the size of the display area so that letters are displayed at desired sizes. The process in which the image conversion processing unit 15′ modifies the size of a display area will be described later in detail. Technologies that the image conversion processing unit 15′ uses for analyzing font sizes are not restricted to a font size analyzing function of a printer driver and OCR technology. Also, a font size analyzing function of a printer driver and OCR technology are already well-known and thus will not be described.

The method in which the image conversion processing unit 15′ modifies the size of a display area will now be described. The image conversion processing unit 15′ analyzes font sizes of a display area (described later in detail) having a predetermined size which is initially set by the document data processing unit 17′. The image conversion processing unit 15′ analyzes sizes of all letters in the display area, and determines a font size of the display area by using either one of determining methods of (a) determining a size of a letter whose font size is the largest of those of letters in the area (maximum value), (b) determining an average value of sizes of letters in the area, and (c) determining a size of a letter which appears most frequently in the area (appearance frequency).

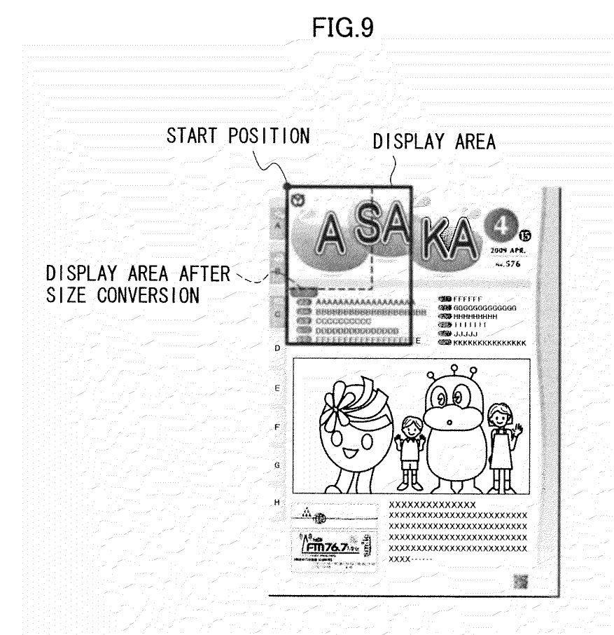

In the example shown in FIG. 9, the image conversion processing unit 15′ determines a font size of a display area as 12 by using the determining method of (c). A method of automatically determining a font size will now be described.

(1) If the difference between the size of a letter whose font size is the largest and the size of a letter whose font size is the second largest is 10 points or more, the determining method of (a) determining a size of a letter whose font size is the largest of those of letters in the area (maximum value) is used. This is because it is highly probable that the largest letter size is a size of a title.

(2) If the difference between the size of a letter which appears most frequently in the area and the size of a letter which appears second most frequently is 10 points or more, the determining method of (c) determining a size of a letter which appears most frequently in the area (appearance frequency) is used. This is because it is probable that a letter which appears most frequently constitutes a text body.

(3) In case of neither the above-described (1) nor (2), the determining method of (b) determining an average value of sizes of letters in the area is used. This is because the letters that appear vary in size.

The image conversion processing unit 15′ acquires a document link conversion method management table from the document data viewing control unit via the data access unit 16. The image conversion processing unit 15′ determines a viewing application for the client portable terminal 20 based on portable terminal information output from the client portable terminal 20 and the document link conversion method management table.

In a viewing application, a size of letters appropriate for displaying on the display unit 21 is set. The image conversion processing unit 15′ refers to a viewing application and acquires information indicating the set size of letters. The image conversion processing unit 15′ converts the size of a display area based on a font size of the display area and the information indicating the set size of letters. The size of a display area is converted with reference to a start position (which will be described later).

As shown in FIG. 9, an explanation will now be given using a case, as an example, in which a font size of a display area is 12. If the size of letters set in a viewing application is 12, the size of letters set in the viewing application and the font size of the display area is the same, and thus the image conversion processing unit 15′ does not modify the size of the display area. If the size of letters set in the viewing application is 18, the size of letters set in the viewing application is three halves of the font size of the display area, and thus the image conversion processing unit 15′ modifies the size of the display area so that it will be a two thirds of the size of the current display area, as shown by the dotted line in FIG. 9.

The document data processing unit 17′ analyzes a layout, a font size, etc. of a document image, and determines the position of a display area based on the result of the analysis. The data processing unit 17′ then outputs a document image within the set display area to the image conversion processing unit 15′ via the data access unit 16.

The method in which the document data processing unit 17′ determines a display area will now be described. A display area is determined in the following sequence.

(A) Method of Determining a Position of a Display Area Based on the Layout of a Document Image

(1) Layout Analysis

The document data processing unit 17′ detects whether there is a letter or not, positions of letters, etc. to analyze the layout of a text image. Whether there is a letter or not, positions of letters, etc. can be detected with edge detection, frequency analysis, etc.

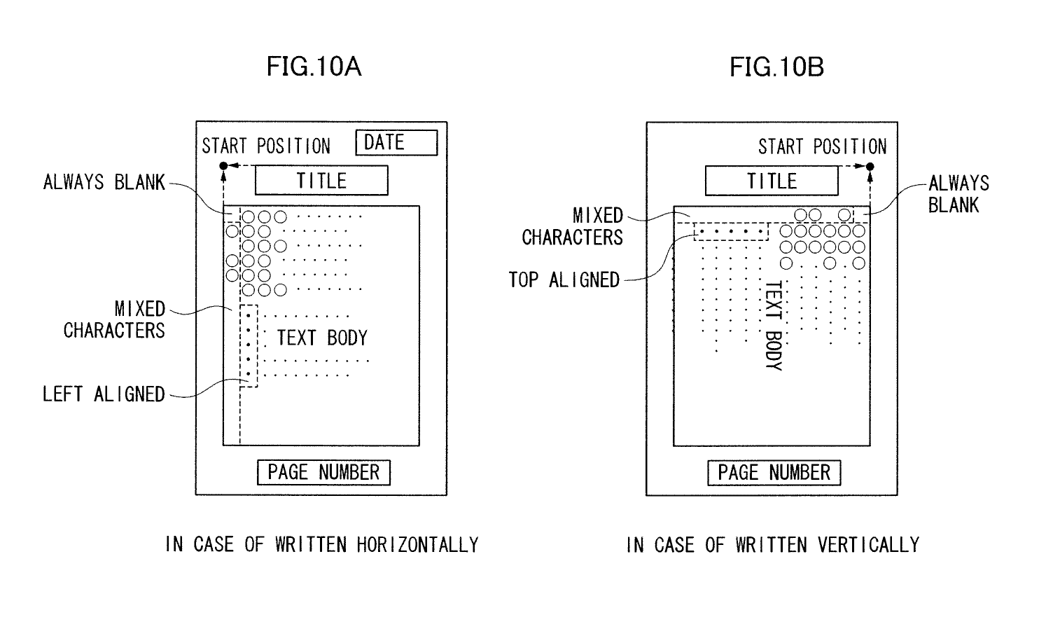

The document data processing unit 17′ analyzes how letters are arranged as well as whether a document is written horizontally (a layout for reading from the upper left to the lower right) or vertically (a layout for reading from upper right to the lower left). This process will now be described specifically using FIGS. 10A and 10B as examples.

The document data processing unit 17′ detects an area where many letters are successively detected as a block of a text body, detects a text structure (whether there is a letter or not, arrangement, etc.) within the block of a text body, and analyzes whether a document is written horizontally or vertically.

FIG. 10A shows an example of a document written horizontally. A document written horizontally is characterized that there is no letter at the upper left corner of a text body area and portions having a letter and having no letter mixedly exist on the leftmost column of a text body. It is also characterized that text is left-aligned at an itemized portion.

FIG. 10B shows an example of a document written vertically. A document written vertically is characterized that there is no letter at the upper right corner of a text body area and portions having a letter and having no letter mixedly exist on the topmost row of a text body. It is also characterized that text is top-aligned at an itemized portion.

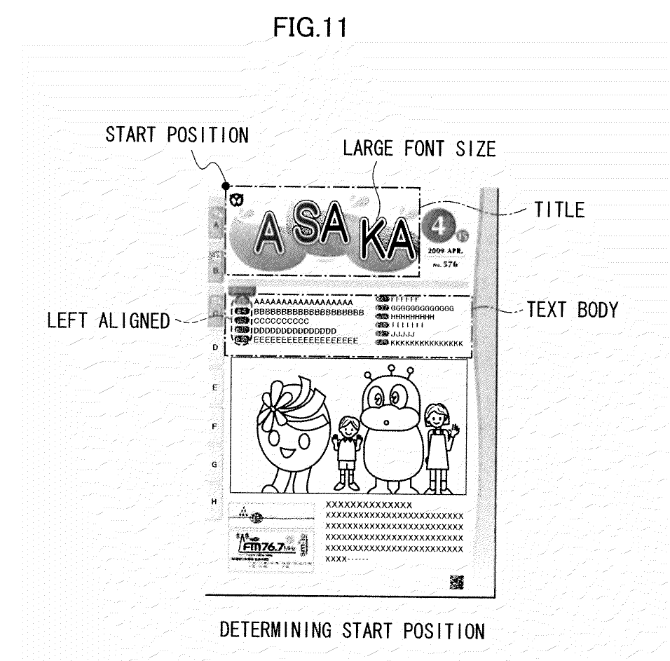

Thus, the document data processing unit 17′ detects these kinds of information and analyzes whether a document is written horizontally or vertically. In case of the document shown in FIG. 11, since text is left-aligned, the document data processing unit 17′ determines that it is a document written horizontally.

(2) Block Analysis

The document data processing unit 17′ analyzes each block of a heading, a title, a text body, a date, etc. The document data processing unit 17′ detects an area where letters are gathered as a block, and determines whether each block represents a heading, a title, a text body, a date, or others. In order to determine this, information is used such as a font size of a heading and a title being larger than that of a text body, a font size of a date being smaller than that of a text body, etc.

In the document shown in FIG. 11, since a font size of letters “A”, “SA”, and “KA”, respectively, is larger than that of other letters, the document data processing unit 17′ determines that the three Japanese letters constitute a title.

(3) Determining a Start Position

The document data processing unit 17′ determines a start position of a display area based on positional information of each block. The document data processing unit 17′ defines an intersection point of an upper end of a title block and a left end of a text body block or a title block as a start position if a document is written horizontally as shown in FIG. 10A, and defines an intersection point of an upper end of a title block and a right end of a text body block or a title block as a start position if a document is written vertically as shown in FIG. 10B.

In the document shown in FIG. 11, since the left end of the title block is left of the left end of the text block, the document data processing unit 17′ defines an intersection point of the upper end of the title block and the left end of the title block, or the upper left end of the title block, as a start position.

(4) Determining a Display Area

The document data processing unit 17′ determines a display area having a predetermined size (such as an area of about ⅙ of a document image) with reference to a start position as an initially set display area.

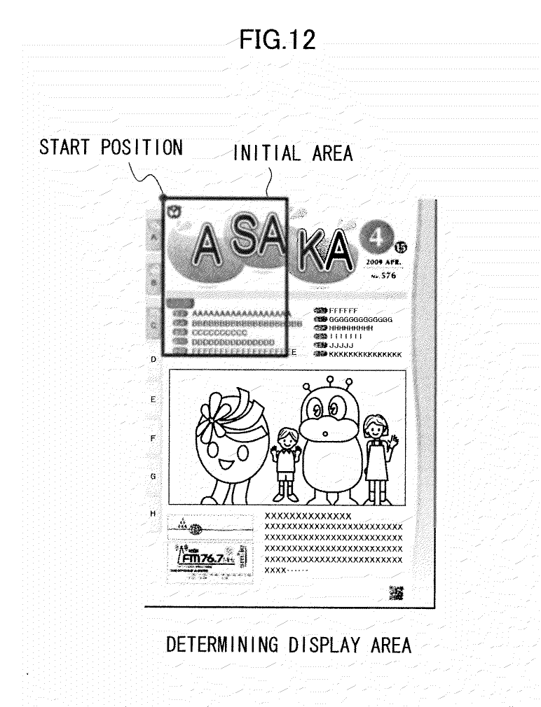

Since the upper left end is a start position as shown in FIG. 11, the document data processing unit 17′ determines an area which is about ⅙ of a document image with reference to the start position as an initially set display area as shown in FIG. 12.

(B) Method of Determining a Position of a Display Area Based on Font Sizes

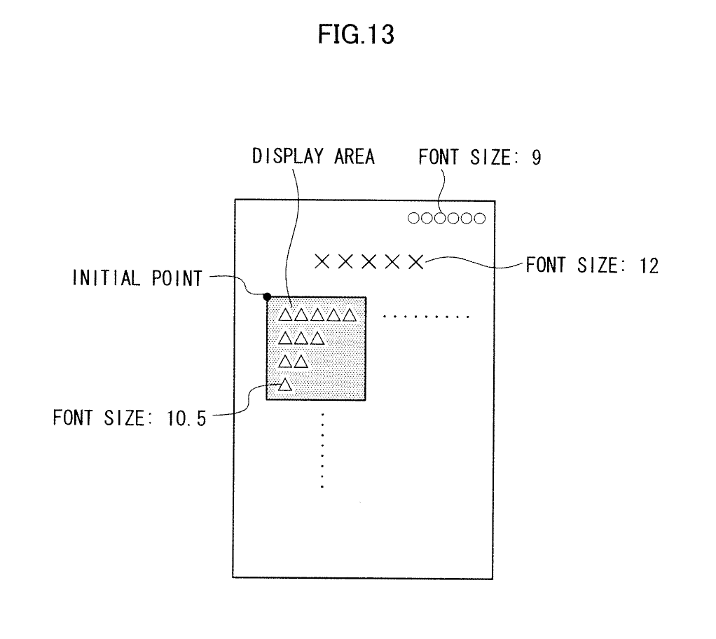

The document data processing unit 17′ analyzes letter positions and font sizes in a text image using technologies such as a font size analyzing function of a printer driver, OCR, etc. In a case shown in FIG. 13, the document data processing unit 17′ detects letters in a font size 9 in the vicinity of the upper right corner, letters in a font size 12 at the substantial center in the vicinity of the upper end, and letters in a font size 10.5 under an area at the substantial center in the vicinity of the upper end.

Generally in document data, a title is written in a font size larger than that of a text body, and a date is written in a font size smaller than that of a text body. Also, letters that constitute a text body are detected most frequently. Thus, in a case shown in FIG. 13, the document data processing unit 17′ determines letters in a font size 10.5, which appear most frequently and whose font size is moderate, as letters constituting a text body.

What a user wants to check the most in document data is a text body. Thus, the document data processing unit 17′ defines the upper left end of letters in a font size 10.5 as a start position, and an area having a predetermined size whose upper left end is at the start position as a display area.

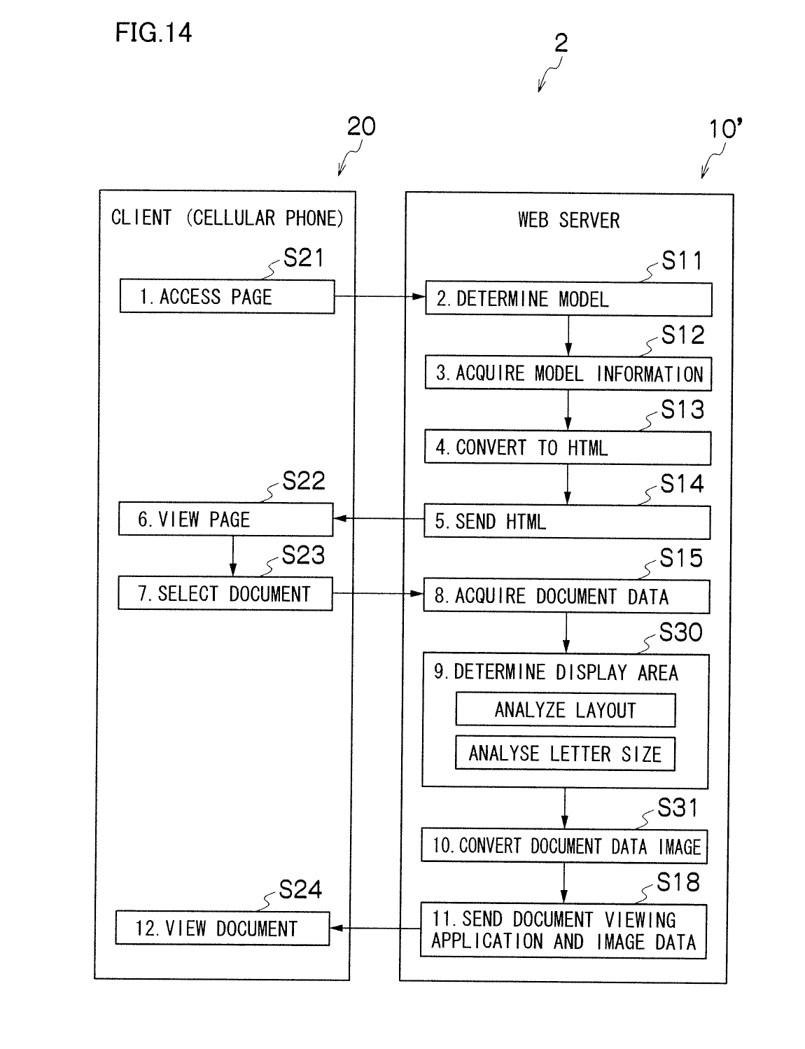

The operation of the image delivery system 2 configured like this will now be described. FIG. 14 is a flow chart showing a process flow for allowing the client portable terminal 20 to view document data.

When a user accesses a particular page by operating the operation unit 23, the system starts and the control unit of the client portable terminal 20 sends portable terminal information from the communication unit 24 to the image delivery apparatus 10 (step S21).

The communication data processing unit 12 of the image delivery apparatus 10 acquires the portable terminal information via the communication unit 11 to output to the model determining unit 13, and the model determining unit 13 analyzes the portable terminal information to determine a model of the client portable terminal 20 (step S11).

The communication data processing unit 12 outputs to the document data viewing control unit 18 the portable terminal information acquired via the communication unit 11. Based on the portable terminal information and a document link conversion method management table, the document data viewing control unit 18 generates an initial screen to be sent to the client portable terminal 20 (step S13).

The communication data processing unit 12 acquires the initial screen in an HTML format generated in step S13 from the document data viewing control unit 18 to output to the communication unit 11, and the communication unit 11 sends the initial screen in an HTML format to the client portable terminal 20 (step S14).

The communication unit 24 of the client portable terminal 20 receives the initial screen in an HTML format to output to the display control unit 22, and the display control unit 22 displays the initial screen in an HTML format on the display unit 21 (step S22). On the initial screen in an HTML format, document data stored in the storage 19 is selectably displayed.

When a user selects a desired document among document data displayed on the initial screen in an HTML format by operating the operation unit 23, the control unit of the client portable terminal 20 sends to the image delivery apparatus 10 via the communication unit 24 the information indicating which document was selected (step S23).

The communication data processing unit 12 acquires via the communication unit 11 the information about a selected document to output to the document data processing unit 17′, and the document data processing unit 17′ acquires from the storage unit 19 via the data access unit 16 a text image which is the document image of the selected document and can be viewed on the client portable terminal 20 (step S15).

The document data processing unit 17′ analyzes a layout, font sizes, etc. of the text image acquired in step S15 to determine an appropriate display area on the text image (step S30). Which analyze method is used to determine a display area depends on an instruction preliminarily input from the client PC 30 or others and stored in the document data processing unit 17′. Also, things such as whether a display area includes both a subject and a text body or just a text body also depend on an instruction preliminarily input from the client PC 30 or others and stored in the document data processing unit 17′.

The document data processing unit 17′ inputs a text image within the display area determined in step S30 (hereinafter referred to as a delivery image) to the image conversion processing unit 15′. The image conversion processing unit 15′ refers to a viewing application and modifies the size of the display area set in step S30 so that letters are displayed at desired sizes. Also, the image conversion processing unit 15′ converts a resolution and a pixel count of the delivery image whose size has been modified based on the information of the display unit 21 acquired in step S12 (step S31).

The image conversion processing unit 15′ outputs the document image of the display area which has been converted in step S31 to the communication data processing unit 12, and the communication data processing unit 12 acquires it. Also, the communication data processing unit 12 refers to a document link conversion method management table (see FIG. 4) stored in the document data viewing control unit 18, and acquires a viewing application for the portable terminal information acquired in step S11 from the image conversion processing unit 15′. Then, the communication data processing unit 12 outputs the acquired document image of the display area and the viewing application to the client portable terminal 20 via the communication unit 11 (step S18).

The communication unit 24 of the client portable terminal 20 receives the document image of the display area and the viewing application to output to the display control unit 22. The display control unit 22 runs the viewing application, and the viewing application displays the document image of the display area on the display unit 21 (step S24).

In this way, the document selected by a user in step S22 is displayed on the display unit 21. If a display area including a subject and a text body such as shown in FIG. 12 is determined, a user can see the beginning portions of the subject and the text body. Also, if a display area including a text body such as shown in FIG. 13 is determined, a user can see the beginning portion of the text body. For example, if a user wants to view the beginning portion of a text body and a text image is initially displayed in full-screen, the user have to input and instruct a display area which he or she wants to be displayed by using the operation unit 23, but by determining a display area so that the beginning portion of a text body is displayed, it is possible to save the effort of instructing a display area.

In this situation, if a user indicates modification of a display area such as moving upward or downward, enlarging or reducing, etc. by operating the operation unit 23, the input instruction details are sent to the image delivery apparatus 10 as with the first embodiment, and a delivery image after the display area has been modified is sent from the image delivery apparatus 10.

In accordance with the present embodiment, a user can recognize the outline of a document by viewing an image initially displayed on the display unit 21 without performing any operation.

Although the above first and second embodiments are described using a system including a client portable terminal and an image delivery apparatus as an example, the present invention is not restricted to a system and can be provided as an image delivery apparatus which delivers images to an external apparatus. Also, the present invention can be provided as a program which is applied to an image delivery apparatus. Also, the client portable terminal is not restricted to a cellular phone, and various portable equipments may be used.

What is claimed is:

1. An image delivery system comprising:
a portable terminal used by a user; and
an image delivery apparatus connected to the portable terminal, wherein
the portable terminal comprises:
a display device;
a terminal-side reception device which receives a delivery image sent from the image delivery apparatus; and
a display control device which displays on the display device the delivery image received by the terminal-side reception device,
the image delivery apparatus comprises:
a document data acquisition device which acquires document data which the display control device cannot display on the display device;
a display device information acquisition device which acquires a pixel count or resolution of the display device;
a display area determining device which determines a display area having a predetermined size on the document data;
an image generating device which generates a delivery image made by imaging document data within the determined display area;
a conversion device which converts a pixel count or resolution of the generated delivery image based on a pixel count or resolution of the display device so that the delivery image is displayed at the same size regardless of a pixel count or resolution of the display device; and
an apparatus-side send device which sends to the portable terminal the delivery image within the display area whose pixel count or resolution is converted by the conversion device.

2. The image delivery system according to claim 1, wherein the display device information acquisition device acquires a size of the display device, and
the display area determining device determines a display area having the predetermined size which is substantially the same as the size of the display device.

3. The image delivery system according to claim 1, wherein the image delivery apparatus comprises a file analysis device which analyzes a layout or letter size of the document data, and
the display area determining device determines the display area based on the result of the analysis.

4. The image delivery system according to claim 2, wherein the image delivery apparatus comprises a file analysis device which analyzes a layout or letter size of the document data, and
the display area determining device determines the display area based on the result of the analysis.

5. The image delivery system according to claim 1, wherein the portable terminal comprises:
an operating unit which inputs information indicating a desired display area in accordance with an instruction by the user; and
a terminal-side send device which sends the input information indicating a desired display area to the image delivery apparatus,
the image delivery apparatus comprises an apparatus-side reception device which receives the information indicating a desired display area sent from the terminal-side send device,
the display area determining device making, based on the received information indicating a desired display area, the desired display area a display area determined on the document data.

6. The image delivery system according to claim 4, wherein the portable terminal comprises:
an operating unit which inputs information indicating a desired display area in accordance with an instruction by the user; and
a terminal-side send device which sends the input information indicating a desired display area to the image delivery apparatus,
the image delivery apparatus comprises an apparatus-side reception device which receives the information indicating a desired display area sent from the terminal-side send device,
the display area determining device making, based on the received information indicating a desired display area, the desired display area a display area determined on the document data.

7. The image delivery system according to claim 1, wherein when a new delivery image is received from the terminal-side reception device after displaying a delivery image on the display device, the display control device erases the delivery image and displays the new delivery image on the display device.

8. The image delivery system according to claim 6, wherein when a new delivery image is received from the terminal-side reception device after displaying a delivery image on the display device, the display control device erases the delivery image and displays the new delivery image on the display device.

9. The image delivery system according to claim 1, wherein the image delivery apparatus comprises a storage device which stores an application with which the delivery image can be viewed,
the send device sends an application stored in the storage device to the portable terminal,
the display control device runs the sent application to display the sent delivery image on the display device.

10. The image delivery system according to claim 8, wherein the image delivery apparatus comprises a storage device which stores an application with which the delivery image can be viewed,
the send device sends an application stored in the storage device to the portable terminal,
the display control device runs the sent application to display the sent delivery image on the display device.

11. An image delivery apparatus constituting the image delivery system according to claim 1.

12. An image delivery method comprising the steps of:
acquiring document data;
acquiring a pixel count or resolution of a display device disposed on a portable terminal;
converting the document data to image data;
determining a display area having a predetermined size on the image data;
converting a pixel count or resolution of image data within the determined display area based on a pixel count or resolution of the display device so that the delivery image is displayed at the same size regardless of a pixel count or resolution of the display device; and
sending to the portable terminal the image data within the display area with which the pixel count or resolution has been converted.

13. A program making an arithmetic unit perform the image delivery method according to claim 12.

14. A recording medium in which computer readable code of the program according to claim 13 is stored.
